(19) United States
(12) Patent Application Publication
(10) Pub. No.: US 2002/0184248 A1
(43) Pub. Date: Dec. 5, 2002

(54) Method, device, and program for controlling file access

(75) Inventor: Seiji Kachi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/160,253

(22) Filed: Jun. 4, 2002

(30) Foreign Application Priority Data
Jun. 5, 2001 (JP) 2001-168966

(51) Int. Cl. G06F 12/00

(52) U.S. Cl. 707/204

(57) ABSTRACT

According to the file access control method of the present invention, a read-only medium and read/write medium are prepared, and when a file update is issued from an application by way of a non-real-time OS, the file that is the object of this update is copied from the read-only medium to the read/write medium under a different name, the copied file is updated, and the name of the file is stored in a correspondence table with a correspondence to the different name of the file that has been copied. Then, when an update of a file is subsequently issued, the correspondence table is checked to find if the object file is listed, and if the object file is not listed, the update process is performed as before. However, if the object file is listed, based on the corresponding different name in the correspondence table, the object file in the read/write medium is updated.

### BACKGROUND OF THE INVENTION

1. Field of the Invention

The present invention relates to a method that can prevent data inconsistencies in a secondary storage device despite power supply cutoffs resulting from any condition, and in particular, to a method that can bring about normal startup of an operating system (OS) in the event of a power supply cutoff.

2. Description of the Related Art

Robot control technology has developed rapidly with the popularization of a variety of portable terminals in recent years. Real-time OS is one closely related technology that has received particular attention. Such an OS is a multitask OS that is prepared with particular importance placed on real-time processing and that is suitable for uses in which an event handler must be immediately activated and processing performed when a particular event occurs.

In the case of a non-real-time OS such as DOS, WINDOWS (registered trademark), and UNIX (registered trademark), if another event (for example, a sudden cutoff of the power supply) should occur when file input/output processing is being executed, the event handler of this event may not be activated until processing is completed, but in a real-time OS, the event handler for this event is reliably activated within a prescribed short time interval.

Real-time OS is therefore suitable for systems that require extremely high-speed processing of events, such as media conversion in which an image that has been recorded is immediately digitized and projected. Further, a real-time OS is designed on the premise of sudden shutoffs of the power supply, and a real-time OS therefore is not configured for operations in which important files relating to the startup of the OS program are rewritten. Thus, data that relate to the operation of the OS are not left in a partially updated state, and the normal startup of the OS can be guaranteed when the power supply is next turned ON.

ITRON (registered trademark) is one representative example of such a real-time OS. Since a real-time OS is often used incorporated within a system, a user is rarely aware of its existence. The above-described ITRON (registered trademark) is incorporated in a variety of equipment, such as portable telephones.

Recently, however, there has been an active trend toward using UNIX (registered trademark) as the real-time OS. UNIX (registered trademark) can readily constitute an open system, includes most applications that operate over this OS, and moreover, features superior connectibility with other systems.

In addition, as previously described, UNIX (registered trademark) is originally a non-real-time OS, operates while accessing a secondary storage device such as a hard disk, and requires a shut-down process by the user before shutting off the power supply of a personal computer or work station in which UNIX (registered trademark) is operating.

Referring now to FIG. 1, a method of controlling file access by a prior-art UNIX (registered trademark) system is next explained. FIG. 1 shows application 41 that operates on UNIX (registered trademark), OS kernel 42 of UNIX (registered trademark) that has been expanded in the main memory of a personal computer or workstation, and read/write medium 43.

Application 41 is, for example, an application that allows the attributes of a prescribed file in read/write medium 43 to be changed in accordance with a log-in request from a user and allows the log-in of the user. In addition, there are also applications that are provided with retrieve-update functions whereby, when one record is retrieved from a database in read/write medium 43, this record is displayed on a display (not shown in the figure), and the user modifies the content of the record, the content of the modification is reflected in the record in the database.

OS kernel 42 schedules commands (tasks) from application 41 and implements exclusive access control when updating a file.

Read/write medium 43 is normally a secondary storage device such as a hard disk, and stores data in a form that can be read and written. In addition to the previously described files that are updated upon log-in and the database that is used by a user, read/write medium 43 stores various OS modules that are read when the OS kernel is activated and numerous management data and control data that are accessed and updated during operation of the OS or applications.

As indicated by the arrows in the figure, when a read command is issued from application 41, OS kernel 42 processes the command and sends to application 41 data in read/write medium 43 that have been designated by the command. When a write command is issued, OS kernel 42 processes the command, and the designated file or file attributes in read/write medium 43 are updated by data from application 41.

In this type of UNIX (registered trademark) system, all data are normally stored in one or a plurality of read/write mediums, and the updated content is saved as is when the power supply is next turned ON.

A non-real-time OS such as UNIX (registered trademark) operates while reading or writing necessary information to a hard disk as required, and if the power supply is suddenly cut off while writing to the hard disk, data inconsistencies may occur, whereby normal reactivation may not be possible when the power supply is next supplied. A user of UNIX (registered trademark) therefore instructs a special pre-termination process referred to as “shut-down” before shutting off the power supply to prevent such inconsistencies.

A UNIX (registered trademark) system that is to be used in a real-time OS, however, necessitates a configuration in which the power supply can be shut off at any time, and this requirement poses the chief obstacle to applying a UNIX (registered trademark) system to real-time OS purposes.

Writing data to a hard disk is realized by performing: (1) the actual file update, and (2) writing information relating to the position (file) of the data (to a file management table within the file system). However, cases may occur in which one of these tasks is not performed due to, for example, a cut-off of the power supply. Such a state will here be referred to as a “data inconsistency.”

Such “data inconsistencies” further include cases in which at least one of a plurality of file sets that are to be updated while maintaining consistency in the system is not normally updated due to, for example, the above-described power supply cutoff.

In the past, problems occurred in which, for example, a sudden cutoff of the power supply caused the head of a hard disk to contact the disk surface and thus destroy data, but currently, when the power supply to a hard disk is interrupted, the head is automatically retracted into a head retraction cylinder that is called a “landing zone,” and the danger of destruction of data resulting from this type of head contact no longer needs to be considered.

### SUMMARY OF THE INVENTION

It is an object of the present invention to provide a method in a UNIX (registered trademark) system that enables normal startup even when the power supply has been cut off for whatever reason without requiring a shut-down process.

It is another object of the present invention to provide a method in which inconsistencies in updated files do not occur even when the power supply is cut off for whatever reason.

According to the method of the present invention for realizing these objects, a read-only medium and a read/write medium are prepared as a secondary storage device, and when a write command is issued from an application, the file that is the object of writing is copied from the read-only medium to the read/write medium, following which this file is updated and a correspondence between the name of the file in the read-only medium and the name in the read/write medium is stored in a correspondence table.

Further, when a command to write a file is subsequently issued, the correspondence table is checked to determine if the object file is in the table. If the file is not in the table, a process similar to the previously described process is performed. If the file is in the table, based on the corresponding name in the correspondence table, the object file in the read/write medium is updated.

Each of the files in the read/write medium that have been produced in this way and the correspondence table are erased when, for example, after the OS is activated when the power supply is next turned ON.

Because updated files are thus collected and managed in the read/write medium and then all erased the next time the power supply is turned ON, the present invention can prevent the occurrence of data inconsistencies that result in the inability to reactivate the OS.

According to the method of the present invention, an OS that can be used as a real-time OS is not limited to a specific OS that operates as UNIX (registered trademark). The method of the present invention is applicable to all non-real-time OS such as other UNIX (registered trademark) operating systems and WINDOWS (registered trademark).

In addition, in the present specification, processes that are expressed by file writing, file updating, and similar expressions include not only updating of the file contents, but also updating of file attributes such as file ownership and time stamps.

According to the first embodiment of the present invention, a file access control method is provided for controlling file access based on request from an application to access a file. This method includes: a determination step for, when an update request is issued from an application for a file that is stored in a first recording medium, using a correspondence table to determine whether the update request is the first update for the file; a first updating step for performing a first update process when it is determined by the determination step that the update request is the first update; a second updating step for performing a second updating process when it is determined in the determination step that the update request is not the first update. The first updating process includes steps of: using the first file name that is designated by the update request to retrieve the file that is the object of updating from the first recording medium, copying the file that is the object of updating that has been retrieved in the second recording medium under a second file name that is different from the first file name, storing the second file name in a correspondence table with a correspondence to the first file name, and updating the file that has been copied in the second recording medium based on the updating request. The second updating process includes steps of: acquiring from the correspondence table the second file name that corresponds to the first file name that is designated by the updating request, and updating the file of the second file name in the second recording medium based on the updating request.

The second embodiment of the present invention is constituted to include: a determination step for, when a reference request is issued from the application for a file that is stored in the first recording medium in the first embodiment, using the correspondence table to determine whether or not an update request was issued in the past for that file; a first reference step for, when it is determined in the determination step that no update occurred in the past, using a first file name that is designated by the reference request to read the file that is the object of reference from the first recording medium and sending the content to the application; and a second reference step for, when it is determined in the determination step that updating has occurred in the past, performing a second reference process. The second reference process includes steps of: acquiring from the correspondence table the second file name that corresponds to the first file name that is designated by the reference request; and reading the file of the second file name in the second recording medium and sending the content to the application.

The third embodiment of the present invention is a method of constituting a real-time OS by means of a non-real-time OS, and includes steps of: after the non-real-time OS has been activated, arranging files that have been updated at least one time in a different location with a file name that is different from the original file name; when an update request is issued for a file that has been updated at least once, effecting control such that the corresponding file that has been arranged at another location under a different name is updated; and before the OS is activated, erasing files that have previously been arranged at a different location.

According to the fourth embodiment of the present invention, a file access control device is provided for controlling file access based on a request from an application to access a file. This device is constituted so as to include: update determination means for, when an update request is issued from the application for a file that is stored in a first recording medium, using a correspondence table to determine whether or not the update request is the first update for that file; a first updating means for, when it has been determined by the update determination means that the update request is the first update, performing a first updating process; and a second updating means for, when it is determined by the updating determination means that the update request is not the first update, performing a second updating process. Here, the first updating means is made up by: retrieving means for using a first file name that is designated by the update request to retrieve a file that is the object of updating from the first recording medium; a copying means for copying the file that is the object of updating that has been retrieved in a second recording medium under a second file name that is different from the first file name; a correspondence table storage means for storing the second file name in a correspondence table with a correspondence to the first file name; and a first copied file updating means for updating the file that has been copied in the second recording medium based on an update request. In addition, the second updating means is made up by: an updated file name acquisition means for acquiring from the correspondence table the second file name that corresponds with the first file name that has been designated by the update request when it has been determined by the update determination means that the update request is not the first update; and second copy file updating means for updating the file of the second file name in the second recording medium based on the update request.

Further, the fifth embodiment of the present invention is constituted to include: an update history determination means for, when a reference request for a file that is stored in the first recording medium is issued from the application in the fourth embodiment, using the correspondence table to determine whether an update request has been issued in the past for that file; a first reference means for, when it has been determined by the update history determination means that no update has occurred in the past, using a first file name that is designated by the reference request to read the file that is to be referenced from the first recording medium and sending the content to the application; and a second reference means for performing a second reference process when it is determined by the update history determination means that an update has occurred in the past. Here, the second reference means is made up by: a referenced file name acquisition means for acquiring from the correspondence table the second file name that corresponds to the first file name that is designated by the reference request; and file reading means for reading the file of the second file name in the second recording medium and sending the content to the application.

Finally, according to the sixth embodiment of the present invention, a file access control device is provided that uses a non-real-time OS and that is constituted to include: a file arranging means for, after the non-real-time OS has been activated, arranging a file that has been updated at least once in a different location and with a file name that is different from the original file name; a control means for, when an update request is issued for a file that has been updated at least once, effecting control such that the corresponding file that has been arranged at a different location under a different name is updated; and erasing means for, before the OS is activated, erasing the file that was previously arranged in a different location.

According to the file access control method of the present invention, a system that is capable of normal reactivation regardless of the conditions in which the power supply was cut off and without requiring a shut-down process can be realized using a non-real-time OS.

According to the present invention, a method is provided by which inconsistencies in updated files do not occur regardless of the conditions in which the power supply was cut off.

The above and other objects, features, and advantages of the present invention will become apparent from the following description based on the accompanying drawings, which illustrate examples of the present invention.

### BRIEF DESCRIPTION OF THE DRAWINGS

FIG. 1 is a schematic representation of the file access method in a UNIX (registered trademark) system of the prior art.

FIG. 2 is a block diagram showing the configuration of a device in which the file access control method of the present invention is applied.

FIG. 3 is a schematic representation of the processing of the file access control method of the first embodiment of the present invention.

FIG. 4 is a flow chart showing the process of the file access control method of the present invention.

FIG. 5 shows an example of the content of a correspondence table of the present invention.

FIG. 6 is a flow chart showing the process for a case of applying the file access control method of the present invention to a telnet log-in process.

FIG. 7 is a schematic representation of the process of the file access control method of the second embodiment of the present invention.

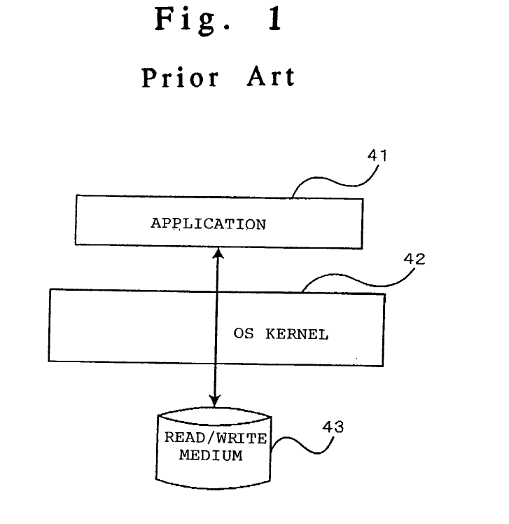

### DETAILED DESCRIPTION OF THE PREFERRED EMBODIMENTS

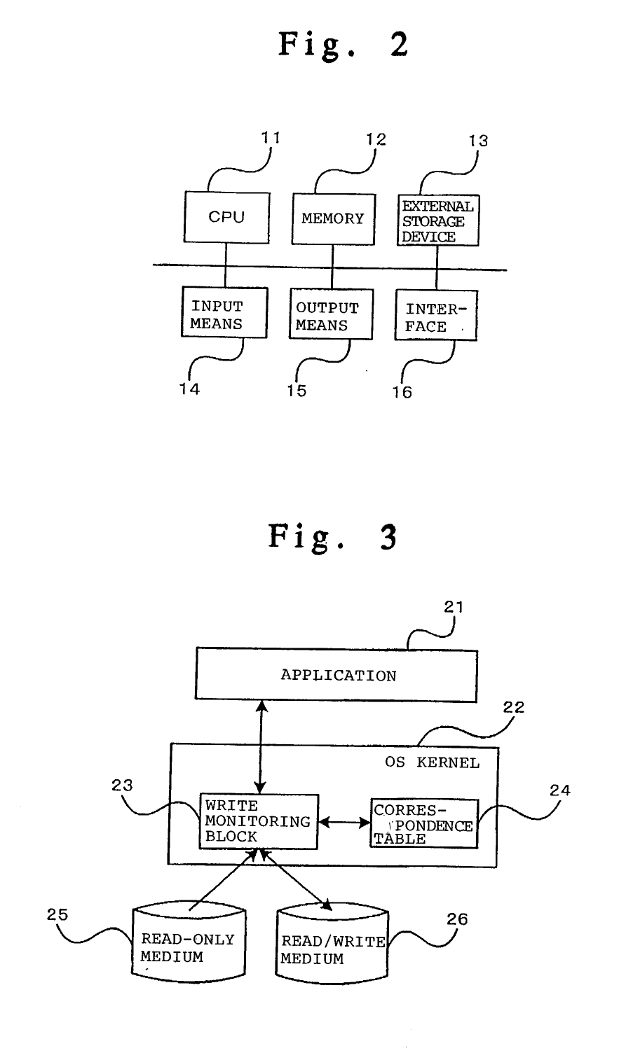

Referring first to FIG. 2, explanation is presented regarding a form in which the method of the present invention is used to incorporate an operating system that is originally a non-real-time OS (for example, Linux is representative of UNIX (registered trademark)) as a real-time OS in a prescribed device. FIG. 2 shows a block diagram of such a device, this device not being limited to any specific device. A wide variety of devices in which a real-time OS is normally incorporated can be considered, including for example, a portable telephone, a portable information device, a measuring device, and a robot control unit.

FIG. 2 is shown for the purpose of explaining the method of the present invention, but the form of incorporating the OS in a device is similar to that of the prior-art real-time OS.

CPU 11 not only controls the operation of each constituent element and data flow, but also performs necessary data processing and computation. In addition, CPU 11 reads and executes instructions from the OS and application programs that have been loaded in memory 12 (to be explained hereinbelow) and executes prescribed functions.

Memory 12 is normally RAM (Random Access Memory) such as DRAM or SRAM, and as previously described, in addition to storing various programs, temporarily stores various data required in processing. The content of programs and data that are stored in memory 12 is erased if the power supply is cut off.

External storage device 13 is normally a secondary storage device of relatively large capacity such as a hard disk, and in the present invention, this external storage device 13 is used as both a read-only medium and a read/write medium. In the method of the present invention, one or a plurality of such storage devices may be used to constitute the read-only medium and the read/write medium. The distinction between the functions of the read-only medium and the read/write medium is managed by means of software, and there is therefore no need for the capability, as hardware, to prohibit or allow writing.

Input means 14 is normally a means for input of the user's instructions, and may correspond to various buttons when the device is a portable telephone or portable terminal.

Output means 15 is typically a display device constituted by an LCD and is used to prompt input of instructions from the user and to display prescribed information.

Interface 16 is, in a wide sense, an interface for exchanging data with the outside and includes standardized data interfaces such as a network interface, RS 232C, or USB. In addition, the previously described OS or application program that is stored on a recording medium such as a CD-ROM can be stored in external storage device 13 by way of interface 16.

The block diagram shown in FIG. 2 is only one example of a device that incorporates a real-time OS. Real-time OS are now incorporated in a wide variety of devices, and the possibility of implementation in various forms other than is shown in FIG. 2 will be obvious to those in the field.

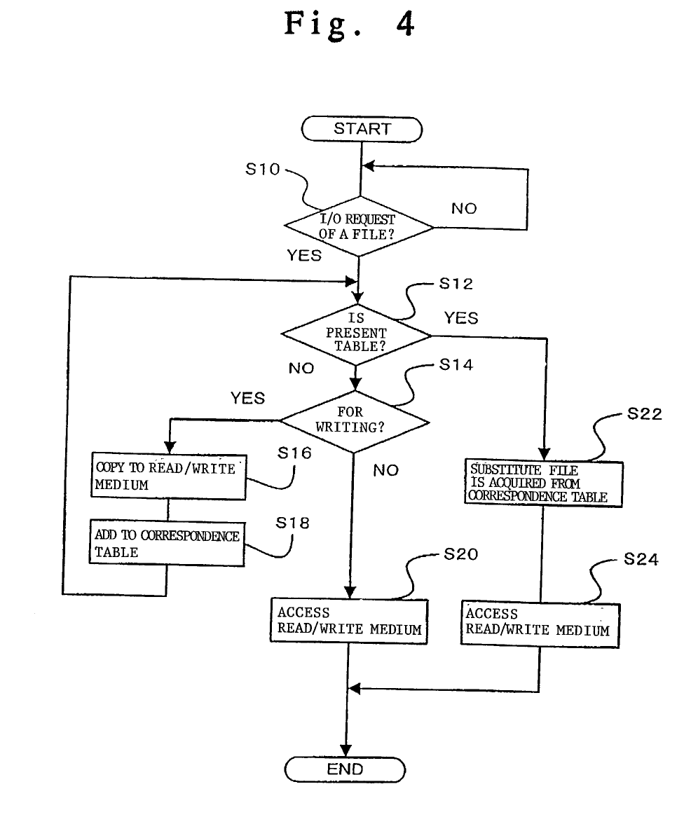

Explanation next regards the first embodiment of the file access control method according to the method of the present invention. FIG. 3 shows a schematic representation of a system in which UNIX (registered trademark) is applied as a real-time OS according to the method of the present invention.

This system includes application 21 that operates in UNIX (registered trademark), OS kernel 22 that is loaded in main memory, read-only medium 25, and read/write medium 26. In addition, OS kernel 22 further includes write monitoring block 23 and correspondence table 24.

Read-only medium 25 stores the OS (in this case, UNIX (registered trademark)) and application programs (load module), and setting files related to these components. The OS program is loaded into main memory (IPL) by the introduction of power supply to the device that was described in FIG. 2, and the UNIX (registered trademark) system is activated. An appropriate application is then activated by the user.

When application 21 refers to a file in read-only medium 25, the read instruction is sent to write monitoring block 23 in OS kernel 22, and this block 23 reads the designated file from read-only medium 25 and sends the file to application 21.

When application 21 updates a file in read-only medium 25, this instruction is similarly sent to write monitoring block 23. Upon determining that this instruction is a write instruction, block 23 then, if the file has not been previously updated, copies the designated file from read-only medium 25 to read/write medium 26, and further, stores the correspondence of the two file names in the correspondence table 24.

When this file is again updated by application 21, correspondence table 24 is used to access and update the relevant file in read/write medium 26.

Thus, files that are stored in read/write medium 26 while the OS is operating are erased if the power supply to the device is interrupted (for example, when the power supply is again introduced), and the correspondence table that is stored in the main memory is inevitably erased by the interruption of the power supply.

Accordingly, the various files that have been stored in read-only medium 25 are only accessed for reading and are not updated in any way, whereby no inconsistencies will occur in the content of each of the files even if the power supply should be suddenly cut off.

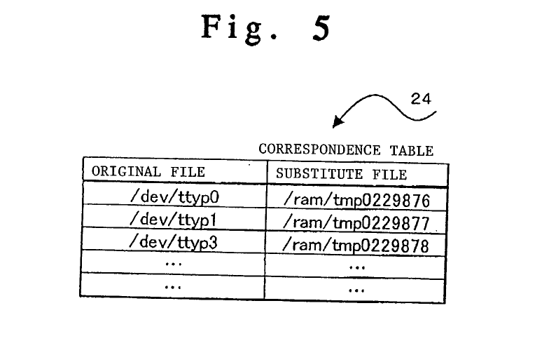

The process of write monitoring block 23 shown in FIG. 3 is next explained in more detail with the flow chart shown in FIG. 4.

Write monitoring block 23 becomes resident in the main memory as a portion of the OS kernel simultaneous with the loading of the OS program to the main memory and monitors whether an I/O request of a file has been issued from application 21 (Step S10). Such I/O requests include not only reference to and updating of the file content, but also reference to and updating of file attributes such as the file owner and time stamp.

When a file I/O request is issued (“YES” in Step S10), it is determined whether or not the file name that is the object of the I/O request is present in the original file names of correspondence table 24 (Step S12). If the file name is not in the table (“NO” in Step S12), the process proceeds to Step S14 in which it is determined whether or not the I/O request is a write (update).

If the I/O request from application 21 is for writing (“YES” in Step S14), the content of the target file in read-only medium 25 is copied to read/write medium 26 in Step S16 and a substitute file name that is different from the original file name is attached.

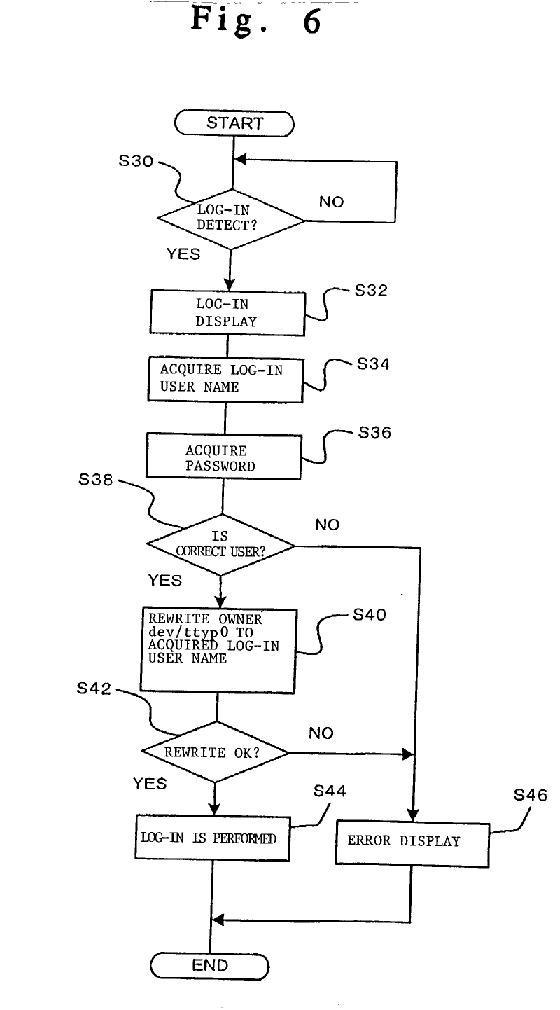

The process next advances to Step S18, in which the pair of the original file name and substitute file name is added as one record to correspondence table 24. FIG. 5 shows an example of correspondence table 24 that has been produced in this way. Correspondence table 24 records original file names and the corresponding substitute file names. To give an example, the substitute file name “/ram/tmp0229876” is assigned as the substitute file name corresponding to the original file name “/dev/ttyp0”.

Accordingly, the file “/dev/ttyp0” in read-only medium 25 is copied in read/write medium 26 as file name “/ram/tmp0229876” in Step S16. In this case, file names follow typical directory notation. For example, “/dev/ttyp0” indicates the file “ttyp0” under the directory “dev” under root directory “/”.

Returning now to the flow chart of FIG. 4, after registering the two file names in correspondence table 24 in Step S18, the process returns to Step S12.

In Step S12, if the file name that is the object of the I/O request exists in the original file names of correspondence table 24 (“YES” in Step S12), the process proceeds to Step S22. Thus, the determination of “YES” in Step S12 comes either immediately after performing the previously described Steps S16 and S18, or after an I/O request of a file has occurred at least once following activation of the OS.

In Step S22, the substitute file name that corresponds to the file name that is the object of an I/O request (the original file name) is acquired from correspondence table 24. Next, in Step S24, the substitute file name that was acquired in Step S22 is used to access read/write medium 26 and update the file in accordance with the instruction from application 21.

When the I/O request from application 21 is determined not to be a write request in Step S14 (“NO” in Step S14), the object file in read-only medium 25 is accessed and read.

Thus, in the file access control method of the present invention, when performing the first update after activation of the OS, the object file is copied from read-only medium 25 to read/write medium 26. Then, a file that has been copied and updated in read/write medium 26 is subsequently deleted together with correspondence table 24 as explained in relation to FIG. 3, and only the file in read-only medium 25 that has not been updated at all is used when the OS is again activated.

The data that can be handled by the method of the present invention are therefore data for which the update content need not be retained, items such as OS programs that are referred to upon each activation being the chief object.

On the other hand, data such as environmental settings data that relate to the OS or applications and data that are updated by an application and retained are not the object of the method of the present invention. Typically, the following two methods can be considered when writing such data that must be held.

The first is a method in which a battery is used such that the power supply cannot possibly turn OFF during writing, a representative example of this method being a portable telephone that operates on a battery. In addition, an ISDN terminal can be constituted such that cut-off of the power supply is absolutely prevented by loading an emergency battery.

According to another method, data are written back to a plurality of storage media and a check sum is also written to enable checking whether the data that have been rewritten back are correct. In this method, either “data before writing” or “data after writing” are saved in another storage medium even if the power supply is turned OFF during writing. Since the check sum will not match if the power supply is turned OFF while writing, correct data can therefore be found upon startup by checking the check sum. In addition to adding a check sum, using a method in which data are written to a plurality of storage media enables, at worst, startup in the state that preceded writing. This method is often used in the BIOS (Basic Input/Output System) of a personal computer.

An example in which the method of the present invention is applied to a telnet log-in process is next described as a case that directly exhibits the effects resulting from the method of the present invention.

FIG. 6 is a flow chart showing the processing of a telnet log-in and the corresponding system.

It is first detected in Step S30 whether a log-in request has been issued via a network to the computer that is the object of log-in. When log-in has occurred (“YES” in Step S30), a log-in screen is displayed on the terminal of the user that logged in (Step S32), and the user is prompted to enter the log-in user name to the log-in screen to acquire the log-in user name (Step S34).

The user is next prompted to enter a password to the log-in screen to acquire the password (Step S36). Then, in Step S38, it is determined from the acquired log-in user name and password whether the user is the correct user. If the user is not legitimate (“NO” in Step S38), the process proceeds to Step S46 in which “error” is displayed on the user's terminal and the process terminated.

If it is determined that the user is legitimate (“YES” in Step S38), the owner of file “/dev/ttyp0” is rewritten to the acquired log-in user name in Step S40. At this time, the file access control method of the present invention that was explained in FIG. 4 is applied. Specifically, the file “/dev/ttyp0” that is stored in read-only medium 25 is copied to read/write medium 26 as the previously described file having the name “/ram/tmp0229876”, following which the owner is changed to the logged-in user name. This change is not an update of the file content itself, but an update of the content of “owner,” which is one of the file attributes.

As previously described, a single record that includes the original file name and the substitute file name is then added to correspondence table 24.

Next, in the event of a failure in the above-described rewrite process due to any cause (“NO” in Step S42), the process proceeds to Step S46, an error is displayed on the user terminal, and the process is terminated.

If the above-described rewrite is successful (“YES” in Step S42), log-in is performed using the logged-in user name in Step S44, whereby the user is able to carry out fixed permitted operation-processing on the network via telnet using the allowed resources of the computer that is the log-in destination.

Next, a case is considered in which /dev/ttyp0 is assumed to be directly updated by a prior-art method in Step S40. The interruption of the power supply during this updating raises the possibility of an inconsistent state in which the contents of file /dev/ttyp0 are updated but the file management information is not updated. If such an inconsistency should occur, subsequent access or reference to file /dev/ttyp0 becomes impossible, and as a result, the log-in process may no longer be possible.

If the system is operated by simply storing this file /dev/ttyp0 in a read-only medium (in which writing is prohibited either by hardware or software means), the danger of the inability to read the file would be eliminated, but such a configuration would also result in an environment in which the ability to rewrite the owner as in Step S40 would be lost and log-in by another user would not be possible.

Thus, according to the method that is described in relation to Step S40 in FIG. 6, telnet log-in can be effected in any state without raising problems that occur when the power supply is interrupted.

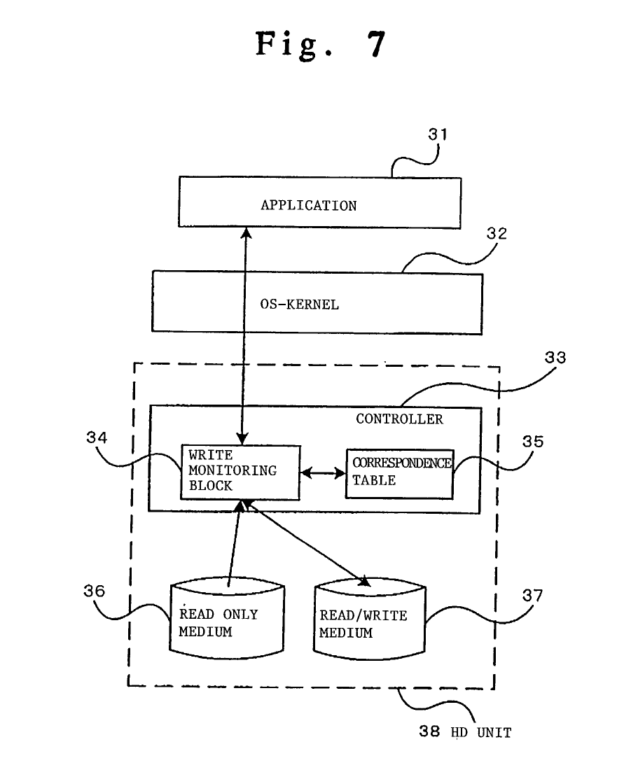

Referring now to FIG. 7, the second embodiment of the file access control method of the present invention is explained.

FIG. 7 is a schematic representation of a system in which UNIX (registered trademark) is applied as a real-time OS according to the method of the present invention.

As with the first embodiment that was shown in FIG. 3, application 31 operates in UNIX (registered trademark), but in contrast with the first embodiment, OS kernel 32 does not include a write monitoring block and correspondence table. These portions are incorporated in controller 33 of HD unit 38, as will be explained hereinbelow.

In this embodiment, therefore, the effects of the present invention can be achieved without amending the OS program. In addition, the elimination of the write monitoring block and correspondence table from the main memory relieves pressure on memory capacity.

HD unit 38 is composed of: controller 33 for controlling I/O to a hard disk, and read-only medium 36 and read/write medium 37 that are constituted by a hard disk. Controller 33 further includes write monitoring block 34 and correspondence table 35. For the purpose of schematic representation, write monitoring block 34 and correspondence table 35 are shown to be included in controller 33 in FIG. 7, but in actuality, a program for executing write monitoring block 34 is loaded in a memory that is included in controller 33 and correspondence table 35 is stored in this memory.

In addition, write monitoring block 34 and correspondence table 35 in this case are equivalent to write monitoring block 23 and correspondence table 24 shown in FIG. 3.

This configuration enables realization of the method of the present invention that was described regarding FIG. 3 or FIG. 6. Write monitoring block 34 and correspondence table 35 are essentially included in HD unit 38 in this second embodiment, but the invention can also be implemented by arranging these components as independent devices between OS kernel 32 and HD unit 38.

While preferred embodiments of the present invention have been described using specific terms, such description is for illustrative purposes only, and it is to be understood that changes and variations may be made without departing from the spirit or scope of the following claims.

What is claimed is:

1. A file access control method for controlling access to files based on a request from an application to access a file, said method comprising:
a determination step for, when an update request is issued from said application for a file that is stored in a first storage medium, using a correspondence table to determine whether or not the update request is the first update for said file;
when it is determined in said determination step that the update request is the first update, performing a first updating step for executing a process comprising steps of:
using a first file name that is designated by said update request to retrieve said file that is the object of said update from said first recording medium;
copying said retrieved file that is the object of said update to a second recording medium under a second file name that is different from the first file name;
establishing a correspondence between said first file name and said second file name and storing this correspondence in the correspondence table; and
updating the file that has been copied in said second recording medium based on said update request; and
when it is determined in said determination step that the update request is not the first update, performing a second updating step for executing a process comprising steps of:
acquiring from said correspondence table said second file name that corresponds to said first file name that is designated by said update request; and
updating the file of said second file name in said second recording medium based on said update request.

2. A file access control method according to claim 1, comprising:
a determination step for, when a reference request is issued from said application for a file that has been stored in said first recording medium, using said correspondence table to determine whether or not an update request was issued in the past for said file;
when it is determined in said determination step that there has been no update in the past, a first reference step for using the first file name that is designated by said reference request to read said file that is the object of reference from said first recording medium and sending the contents to said application; and
when it is determined in said determination step that there has been an update in the past, a second reference step for executing a process comprising steps of:
acquiring from said correspondence table said second file name that corresponds to the first file name that is designated by said reference request; and
reading the file of said second file name in said second recording medium and sending the content to said application.

3. A file access control method according to claim 1, wherein the content of said correspondence table and the content of said second recording medium are erased by the reintroduction of the power supply to the device that implements said file access control method.

4. A file access control method according to claim 3, wherein said determination step for determining whether or not said update request is the first update for said file is realized by determining whether or not said first file name that is designated by said update request is stored in said correspondence table.

5. A file access control method according to claim 3, wherein said determination step for determining whether or not there has been an update request in the past for a file that is the object of said reference request is realized by determining whether or not said first file name that is designated by said reference request is stored in said correspondence table.

6. A method of constituting a real-time OS from a non-real-time OS, the method comprising steps of:
after start-up of said non-real-time OS, arranging files that have been updated at least one time in a different location under a file name that is different from the original file name;
effecting control such that, when an update request is issued for a said file that has been updated at least one time, said corresponding file that has been arranged in a different location under a different file name is updated; and
erasing files that have been previously arranged in a different location before startup of said OS.

7. A file access control device for controlling access to files based on a request from an application to access a file, comprising:
an update determination means for, when an update request is issued from said application for a file that is stored in a first recording medium, using a correspondence table to determine whether or not said update request is the first update request for the file;
when it is determined by said update determination means that said update request is the first update, a first updating means comprising:
a retrieval means for using the first file name that is designated by said update request to retrieve the file that is the object of said update from said first recording medium;
a copying means for copying the retrieved file that is the object of said update in a second recording medium under a second file name that is different from said first file name;
a correspondence table storage means for storing said second file name in said correspondence table with a correspondence to said first file name; and
a first copied file updating means for updating the file that has been copied in said second recording medium based on said updating request; and
when it is determined by said update determination means that said update request is not the first update, a second updating means comprising:
updated file name acquisition means for acquiring from said correspondence table said second file name that corresponds to the first file name that is designated by said update request; and
second copied file updating means for updating the file of said second file name in said second recording medium based on said update request.

8. A file access control device according to claim 7, comprising:
an update history determination means for, when a reference request is issued from said application for a file that is stored in said first recording medium, using said correspondence table to determine whether or not there has been an update request in the past for that file;
when it is determined by said update history determination means that there has been no update in the past, a first reference means for using a first file name that is designated by said reference request to read from said first recording medium the file that is the object of said reference request and sending the content to said application; and
when it is determined by said update history determination means that there has been an update in the past, a second reference means comprising:
referenced file name acquisition means for acquiring from said correspondence table said second file name that corresponds to the first file name that is designated by said reference request; and
file reading means for reading the file of said second file name in said second recording medium and sending the contents to said application.

9. A file access control device according to claim 7, wherein each of said means operates in a UNIX (registered trademark) system.

10. A file access control device according to claim 8, wherein each of said means operates in a UNIX (registered trademark) system.

11. A file access control device according to claim 9, wherein each of said means and said correspondence table are incorporated in an OS kernel of a UNIX (registered trademark) system.

12. A file access control device according to claim 7, wherein said first recording medium and said second recording medium are constituted by a hard disk.

13. A file access control device according to claim 8, wherein said first recording medium and said second recording medium are constituted by a hard disk.

14. A file access control device according to claim 12, wherein each of said means operates in a controller of said hard disk.

15. A file access control device according to claim 13, wherein each of said means operates in a controller of said hard disk.

16. A file access control device that uses a non-real-time OS, said device comprising:
a file arranging means for, after startup of said non-real-time OS, arranging files that have been updated at least one time in a different location and under a different name from the original file name;
a control means for, when an update request has been issued for a said file that has been updated at least one time, updating said corresponding file of a different file name that has been arranged in a different location; and
erasing means for erasing said files that have been previously arranged in a different location before startup of said OS.

17. A program for causing a computer to function as a file access control device that comprises:
an update determination means for, when an update request has been issued from an application for a file that is stored in a first recording medium, using a correspondence table to determine whether or not the update request is the first update for that file;
when it is determined by said update determination means that said update request is the first update, a first updating means comprising:
a retrieval means for using a first file name that is designated by said update request to retrieve the file that is the object of said update from said first recording medium;
a copy means for copying said retrieved file that is the object of update to a second recording medium under a second file name that is different from said first file name;
a correspondence table storage means for storing said second file name with a correspondence to said first file name in said correspondence table; and
a first copied file updating means for updating the file that has been copied in said second recording medium based on said update request; and
when it is determined by said update determination means that said update request is not the first update, a second updating means comprising:
updated file name acquisition means for acquiring from said correspondence table said second file name that corresponds to a first file name that is designated by said update request; and
second copied file updating means for updating the file of said second file name in said second recording medium based on said update request.

18. A program according to claim 17 for causing a computer to function as a file access control device that further comprises:
an update history determination means for, when a reference request has been issued from said application for a file that is stored in said first recording medium, using said correspondence table to determine whether or not an update request has been issued in the past for that file;
when it is determined by said update history determination means that there has been no update in the past, a first reference means for using a first file name that is designated by said reference request to read the file that is the object of said reference request from said first recording medium and sending the content to said application; and
when it is determined by said update history determination means that there has been an update in the past, a second reference means that comprises:
referenced file name acquisition means for acquiring from said correspondence table said second file name that corresponds to the first file name that is designated by said reference request; and
a file reading means for reading the file of said second file name in said second recording medium and sending the contents to said application.
